(19) United States
(12) Patent Application Publication
(10) Pub. No.: US 2015/0095892 A1
(43) Pub. Date: Apr. 2, 2015

(54) SYSTEMS AND METHODS FOR EVALUATING A CHANGE PERTAINING TO A SERVICE OR MACHINE

(71) Applicant: Linkedln Corporation, Mountain View, CA (US)

(72) Inventors: Nicholas Baggott, Mountain View, CA (US); Christopher Coleman, Sunnyvale, CA (US); Melvin Yueyang Du, Dublin, CA (US); Thomas Goetze, Danville, CA (US); Ritesh Maheshwari, Mountain View, CA (US); Badrinath K. Sridharan, Saratoga, CA (US); Toon Sripatanaskul, Menlo Park, CA (US); Cuong Tran, Los Altos, CA (US)

(73) Assignee: Linkedln Corporation, Mountain View, CA (US)

(21) Appl. No.: 14/040,470

(22) Filed: Sep. 27, 2013

(51) Int. Cl. G06F 11/36

(52) U.S. Cl. CPC G06F 11/3612
USPC 717/127

(57) ABSTRACT

Techniques for evaluating the performance of a service or machine after a change that pertains to the service or machine are described. For example, an indication of a change that pertains to a service or machine is received. In response to the receiving of the indication of the change, using at least one computer processor, a performance of the service or machine after the change is evaluated. The evaluation may be based on a particular rule for evaluating the performance of the service or machine after the change. An evaluation result is generated based on the evaluating of the performance of the service or machine after the change. The evaluation result indicates the quality of the performance of the service or machine after the change.

### TECHNICAL FIELD

The present disclosure generally relates to data processing systems. More specifically, the present disclosure relates to methods, systems, and computer program products for evaluating a change pertaining to a service or machine. The evaluation may be performed based on a rule for evaluating the quality of the performance of the service or machine after the change.

### BACKGROUND

Some companies use one or more development environments, test environments, verification environments, and production environments during a product development lifecycle of a product. Examples of a product are a software product, a software-as-a-service (“SaaS”) product, or a hardware product. An environment used in the product development lifecycle usually includes a particular configuration of hardware, software, and operating system. Various environments (also called “fabrics”) comprise one or more physical or virtual machines, as well as certain software, that are dedicated to a particular purpose or functionality. For example, in a software development environment, machines and associated software are used by software engineers to write software code for a software product, and to perform unit testing of the respective software code of the software product. Next, the software code may be tested by the Quality Assurance engineers within a test environment that allows for integration testing (e.g., testing the inter-operability of several software components). The software code may undergo further testing within a staging environment where end-to-end testing of the software code may be performed. At this stage in the software development cycle, the engineers may test the functionality of the software product based on the particular software code in order to verify the functionality from a perspective of a user of the software product.

Traditionally, when a change (e.g., a deployment of a new version of code, or a modification in hardware or in the configuration of a system) needs to occur in any of a company's environments, the engineers choose one of two alternative methods to evaluate the impact of the change on the performance of, for example, the underlying hardware, an application or service, a network, a database, etc. The first alternative includes making a certain change in a production environment and observing what happens as a result of the change. The second alternative includes rigorous testing of the change in a non-production test environment against a number of criteria and subsequent implementation of the change in the production environment.

### DESCRIPTION OF THE DRAWINGS

Some embodiments are illustrated by way of example and not limitation in the FIGs. of the accompanying drawings, in which:

FIG. 1 is a functional representation of an example change evaluating system, according to various example embodiments;

FIG. 2 is a network diagram depicting an example network environment, within which various example embodiments of a change evaluating system may be deployed;

FIG. 3 is a block diagram of certain modules of an example change evaluating system, consistent with some example embodiments;

FIG. 4 is a flowchart diagram illustrating method steps of an example method for evaluating a change pertaining to a service or machine, consistent with some example embodiments;

FIG. 5 is a flowchart diagram illustrating method steps of an example method for evaluating a change pertaining to a service or machine, consistent with some example embodiments;

FIG. 6 lists examples of rules for evaluating the performance of the service or machine after the change, according to various example embodiments;

FIG. 7 lists examples of rules for evaluating the performance of the service or machine after the change, according to various example embodiments; and

FIG. 8 is a block diagram of a machine in the example form of a computer system within which a set of instructions, for causing the machine to perform any one or more of the methodologies discussed herein, may be executed.

### DETAILED DESCRIPTION

The present disclosure describes methods, systems, and computer program products for evaluating a change that pertains to a service or machine based on a rule for evaluating the quality of the performance of the service or machine after the change. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

Conventionally, a company that develops a product may use a number of environments to bring the product to maturity. Examples of such environments are a development environment, a testing environment, an integration environment, a verification environment, and a production environment. Often, during a product's development lifecycle, either the product being developed or the environments in which the product is developed undergo changes. The term “change” is used broadly herein, and refers to a modification to the existing condition or state of affairs of a product being created or an environment used in the product development lifecycle. Examples of changes are a release of new software code, an addition of hardware to a machine, a removal of hardware from a machine, a modification of hardware of a machine, an upgrade of the operating system of a machine, an upgrade in the software used for developing or testing a product, a modification in a configuration (e.g., of a database, a machine, or a network), or a modification in a pattern of traffic (e.g., an increase in user traffic) to a web site. Also, the term “product” is used broadly herein, and refers to software, hardware, or a service. A service is work performed (or offered) by a server. This may be simply serving simple requests for data to be sent or stored (as with file servers, gopher or HyperText Transfer Protocol (HTTP) servers, e-mail servers, finger servers, Structured Query Language (SQL) servers, etc.); or it may be more complex work, such as that of Internet Relay Chat (IRC) servers, print servers, X Windows servers, process servers, etc.

The process of creating a product (e.g., software, hardware, or a service) may be very complex. Changes to the products being built, as well as to the environments used for building the products, may result in numerous problems. New software code in a product may include bugs that impact the functionality of the product. A web-based service may include a new feature that is very successful with the users of the service, and the popular demand for the new feature may cause an unexpected increase in user traffic (e.g., increased number of requests) to a web site. A newly added network server hosting a production web server may crash due to hardware failure.

Traditionally, when a change (e.g., a deployment of a new version of code, or a modification in hardware or in the configuration of a system) needs to occur in any of a company's environments, the engineers choose one of two alternative methods to evaluate the impact of the change on the performance of, for example, the underlying hardware, an application or service, a network, a database, etc. The first alternative includes making a certain change in a production environment and observing what happens as a result of the change. The second alternative includes rigorous testing of the change in a non-production test environment against a number of criteria and subsequent implementation of the change in the production environment. However, both of these traditional methods of evaluating changes have drawbacks. A disadvantage of the first alternative is receiving unexpected results which may be very costly to the company. A disadvantage of the second alternative is the long time it takes to bring (e.g., implement) the change to the production environment. That may affect the speed at which a company operates.

According to various example embodiments, a change evaluating system may evaluate the quality of the performance of the service or machine after the change as soon as the change occurred instead of waiting for an alert about a problem. The change evaluating system may, based on the evaluation, identify the changes that are (or may become) problematic to the performance of a service or machine. Accordingly, any issues that may stem from the problematic changes may be promptly addressed.

The subject matter described herein may allow a change evaluating system (also “system”) to evaluate a change that pertains to a service, machine, or software (also “change”) based on evaluating the performance of the service, machine, or software in relation to (e.g., after) the change. The evaluation may be performed based on a rule for evaluating the performance of the service or machine after the change. The change evaluating system may determine whether the change negatively impacts any aspects of the performance of the service, machine, or software, or whether the performance after the change is as good as or better than the performance before the change occurred. Because changes that pertain to a service, machine, or software code that is being either developed into a product or used in developing the product may affect the performance of the service, machine, or software code, as perceived by a user (e.g., an end-user of the product), a prompt evaluation of these changes may be beneficial to the company. Further, by evaluating each change immediately after the change occurs, the change evaluating system may provide valuable information with regard to any possible problems that may occur as a result of the change before the problems actually occur. A prompt evaluation of changes and correction of issues that may lead to problems allows for efficient allocation of resources within the company, a higher product quality, and a faster release of the product.

In some example embodiments, the change evaluating system receives an indication of a change that pertains to a service or machine. In response to the receiving of the indication of the change, the change evaluating system automatically evaluates, using at least one computer processor, a performance of the service or machine after the change, based on a particular rule for evaluating the performance of the service or machine after the change. The change evaluating system generates an evaluation result based on the evaluating of the performance of the service or machine after the change. The generating of the evaluation result may be performed using one or more algorithms. The evaluation result may indicate (e.g., include an indication of) the quality of the performance of the service or machine after the change.

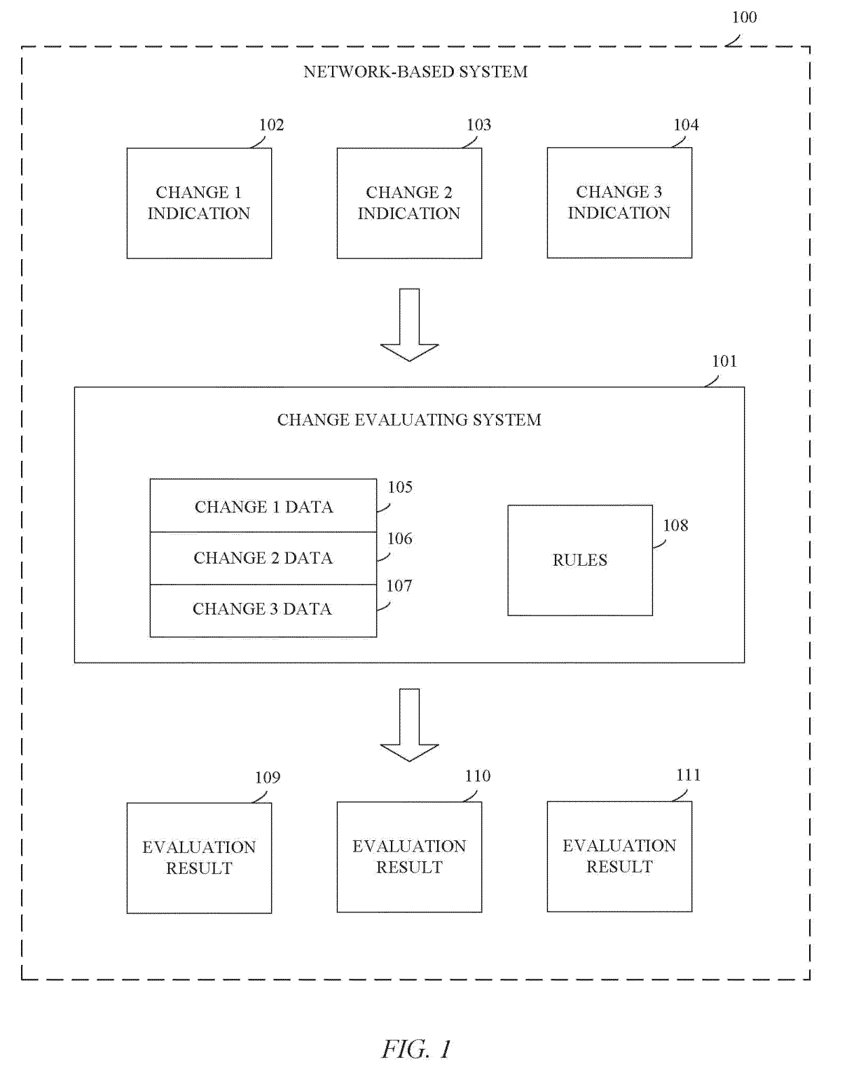

FIG. 1 is a functional representation of an example change evaluating system 101 for evaluating a change pertaining to a service or machine based on evaluating the performance of the service or machine after the change has occurred, according to various example embodiments. In some example embodiments, the change evaluating system 101 is included in a network-based system 100. As described in more detail below, the change evaluating system 101 may receive an indication (e.g., change indication 102, change indication 103, or change indication 103) that a change that pertains to a service or machine has occurred. In response to receiving the indication of the change, the change evaluating system 101 evaluates, using at least one computer processor, a performance of the service or machine after the change, using a particular rule 108 for evaluating the quality of the performance of the service or machine after the change. In some example embodiments, the particular rule 108 indicates a minimum performance level of the service or machine (e.g., that satisfies a particular Service Level Agreement (SLA).) Upon evaluating the performance of the service or machine, the change evaluating system 101 generates an evaluation result (e.g., evaluation result 109, evaluation result 110, or evaluation result 111) based on the evaluating of the performance of the service or machine after the change. The evaluation result may indicate the quality of the performance of the service or machine after the change.

The change evaluating system 101 may continuously monitor the service or machine for an occurrence of a change that pertains to the service or machine. In some example embodiments, the change evaluating system 101 includes a listener component (or module) configured to automatically receive indications of changes sent by one or more reporting agent components configured to send communications that indicate that one or more changes occurred with regards to (e.g., to) a service or machine. In certain example embodiments, the change evaluating system 101 is manually invoked by a person who made a change to a service or machine. Alternatively or additionally, the invocation of the change evaluating system 101 may be performed automatically in response to a client request from one or more automated systems.

To evaluate the performance of a service or machine after the change, the change evaluating system 101 may analyze data associated with the respective change (e.g., change 1 data 105, change 2 data 106, or change 3 data 107) in light of one or more rules 108 that are applicable based on the respective change. More specifically, in some example embodiments, the change evaluating system 101 determines a type of change (e.g., change to software, hardware, configuration, service, etc.) based on the indication of the change. Further, the change evaluating system 101 selects, based on the type of change, a particular rule 108 from a plurality of rules 108. The particular rule 108 may specify a condition, such as a minimum performance level of the service or machine, or a lack of a particular type of performance problem. The change evaluating system 101 also accesses data that pertains to the performance of the service or machine after the change (e.g., change 1 data 105, change 2 data 106, or change 3 data 107), applies the particular rule 108 to the data that pertains to the performance of the service or machine after the change, and determines whether the condition specified in the particular rule 108 is satisfied by the data that pertains to the performance of the service or machine after the change.

In some example embodiments, the type of change includes a deployment of a new version of a software code. The new version of the software code is different from a baseline (e.g., a previous) version of the software code. The change evaluating system 101 accesses data that pertains to a performance of the service or machine before the change (also “baseline data”). The baseline data is collected during an execution of the baseline version of a software code. The change evaluating system 101 also accesses data that pertains to a performance of the service or machine after the change (also “change data”). The change data is collected during an execution of the new version of the software code. In some instances, a particular rule may include a condition that specifies that an exception appears in the change data (e.g., data collected during the execution of the new version of the software code) but is absent from the baseline data (e.g., data collected during the execution of the baseline version of the software code). The evaluating of the performance of the service or machine after the change may include analyzing the baseline data and the change data according to the particular rule. The evaluating of the performance of the service or machine after the change may also include determining that the condition specified in the particular rule is satisfied by the baseline data and the change data based on identifying an exception that is present in the change data and that is absent from the baseline data.

In some example embodiments, the type of change includes a change in a memory performance of the service. The determining by the change evaluating system 101 that the condition specified in the particular rule is satisfied by the data may include determining that the memory performance of the service is at or above a baseline level based on a Java Virtual Machine (JVM) spending less than a pre-determined percentage value of its time in garbage collection during an analysis period.

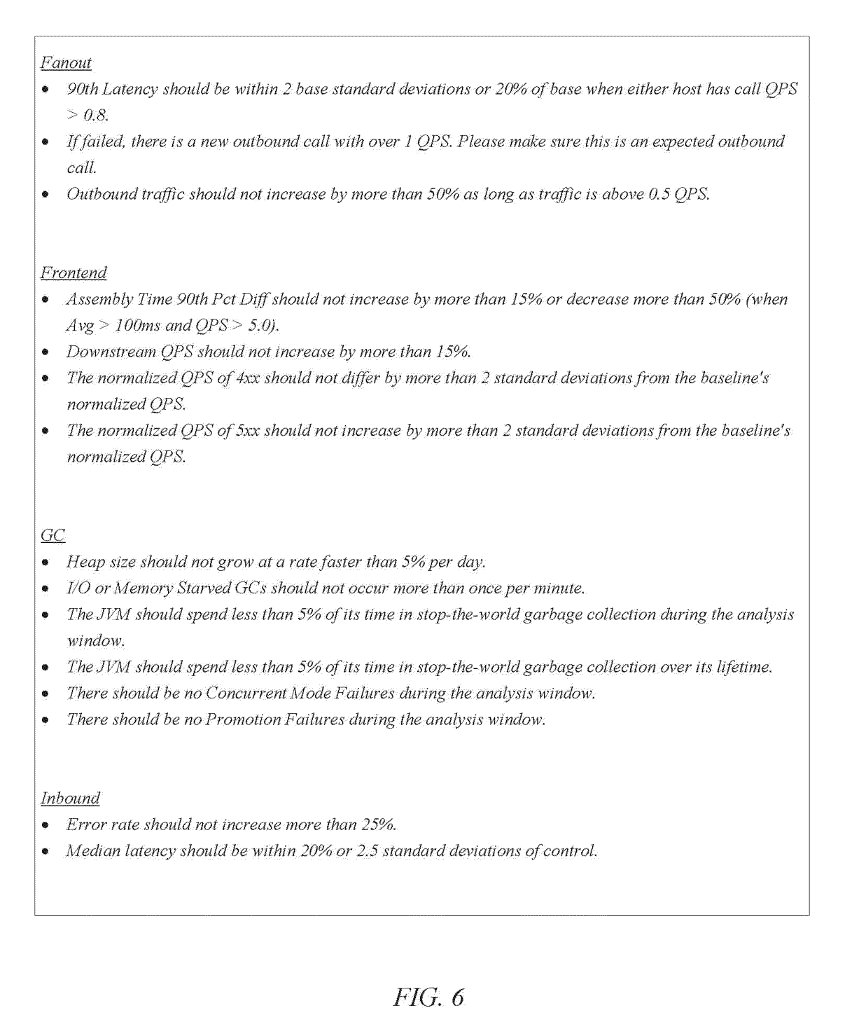

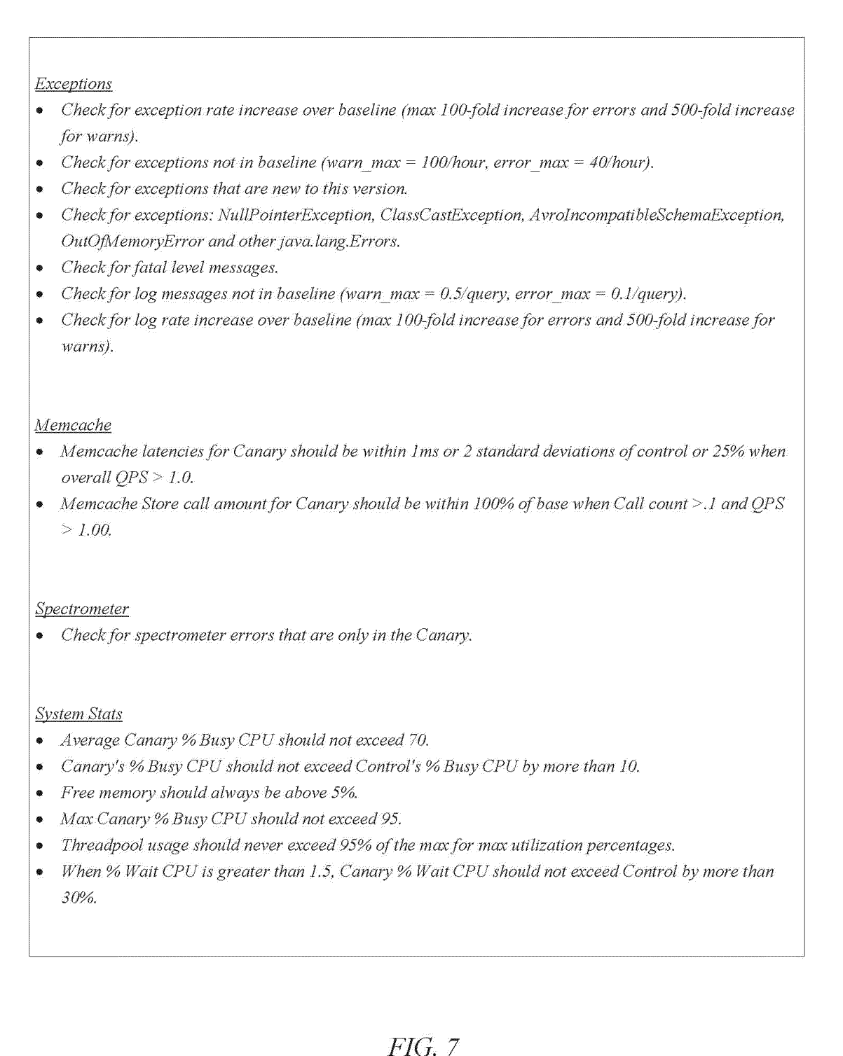

Example rules for evaluating the performance of the service or machine after the change are listed in FIG. 6 and FIG. 7.

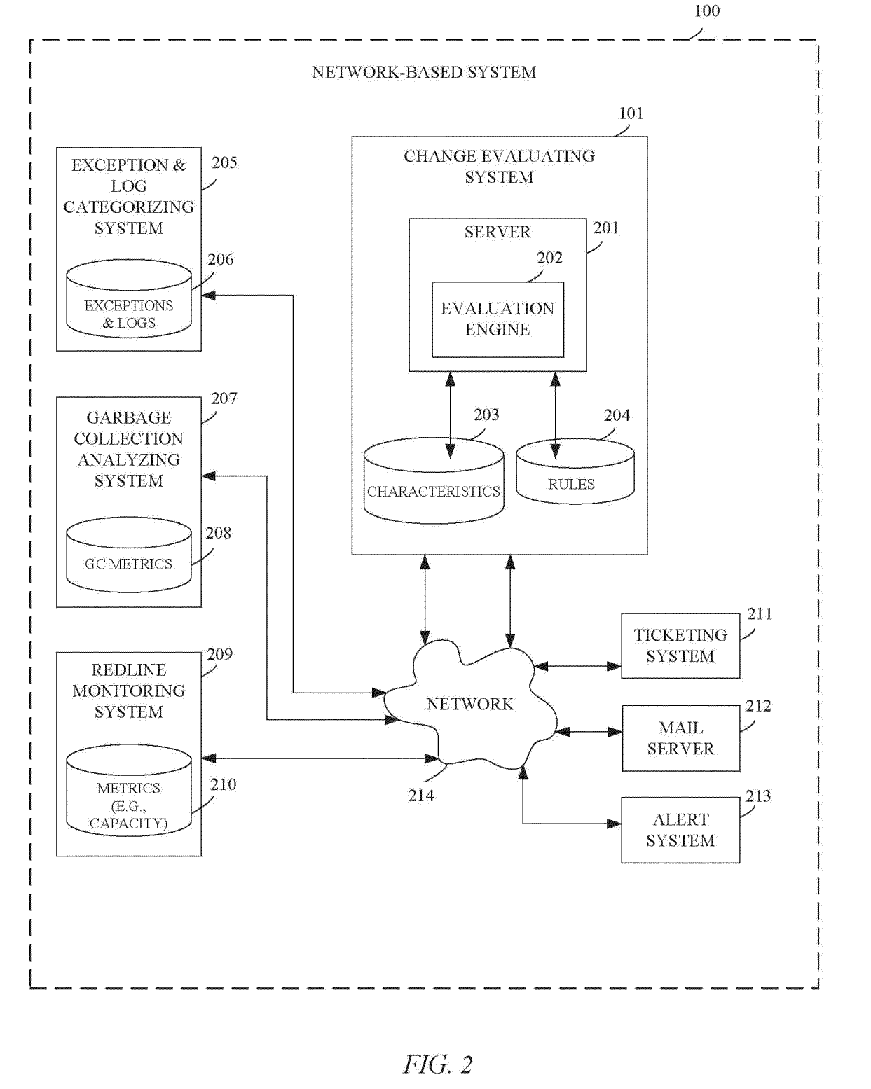

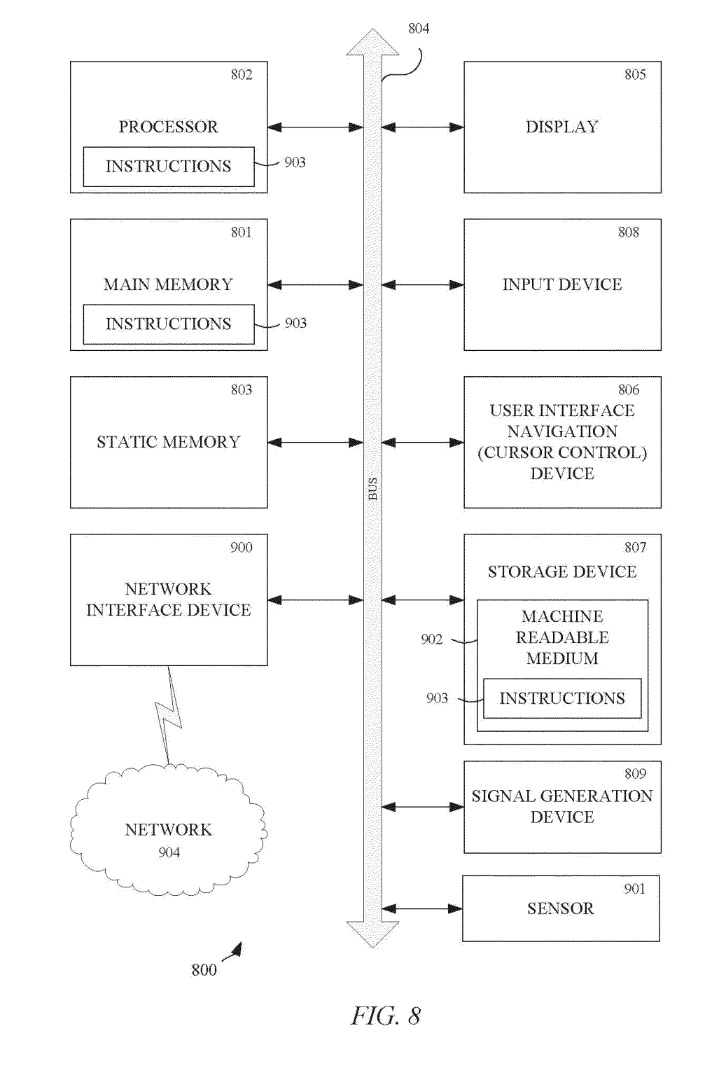

FIG. 2 is a network diagram depicting an example network environment 100, within which various example embodiments of a change evaluating system may be deployed. The network environment 100 includes a change evaluating system 101, an exception and log categorizing system 205, a garbage collection analyzing system 207, a redline monitoring system 209, a ticketing system 211, a mail server 212, and an alert system 213, all communicatively coupled to each other through a network 214. The change evaluating system 101, the exception and log categorizing system 205, the garbage collection analyzing system 207, the redline monitoring system 209, the ticketing system 211, the mail server 212, and the alert system 213 may each be implemented in a computer system, in whole or in part, as described below with respect to FIG. 8.

As is understood by skilled artisans in the relevant computer and Internet-related arts, each module or engine shown in FIG. 2 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, a skilled artisan will readily recognize that various additional functional modules and engines may be used with a change evaluating system, such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The change evaluating system 101 may, in some example embodiments, include a server 201 which may be communicatively coupled to other machines, servers, or devices of the network-based system 100. The server 201 may include an evaluation engine 202, which may include one or more modules for evaluating a change that pertains to a service or machine. In some example embodiments, the server 201 may be communicatively coupled to a characteristics database 203 and to a rules database 204. The characteristics database 203 and the rules database 204 may reside on one or more physical or virtual machines.

The change evaluating system 101 in FIG. 2 may access (or receive) from the exception and log categorizing system 205, the garbage collection analyzing system 207, and the redline monitoring system 209 performance-related data that pertains to the performance of a service or machine. The data that pertains to the performance of a service or machine may, for example, be stored in one or more records of the exceptions and logs database 206, the Garbage Collection (GC) metrics database 208, or the capacity metrics database 210 that may or may not be part of the exception and log categorizing system 205, the garbage collection analyzing system 207, or the redline monitoring system 209, respectively. Using the performance-related data that pertains to a service or machine, the change evaluating system 101 may determine how the service or machine performs after the change that pertains to the service or machine has been implemented (or has occurred).

As illustrated in FIG. 2, with some example embodiments, the evaluation engine 202 is implemented as a service that operates in conjunction with various automated systems, such as the exception and log categorizing system 205, the garbage collection analyzing system 207, and the redline monitoring system 209. For instance, any number of automated systems may invoke the functionality of the evaluation engine 202 to receive evaluations of performances of services or machines after certain changes occurred. However, with various alternative embodiments, the evaluation engine 202 may be implemented as its own application server module such that it operates as a stand-alone application.

With some embodiments, the evaluation engine 202 may include or have an associated publicly available application programming interface (API) that enables third-party applications to invoke the functionality of the evaluation engine 202. While the applications and services that utilize (or leverage) the evaluation engine 202 are generally associated with the operator of the change evaluating system 101, certain functionalities of the evaluation engine 202 may be made available to third parties under special arrangements. In some example embodiments, third-party applications may invoke the functionality of the evaluation engine 202 using a “software as a service” (SaaS) or a stand-alone (turnkey or on-premise) solution.

An indication of a change may be received at the change evaluating system 101 using any of the methods known to those of ordinary skill in the art. In some example embodiments, certain events (or changes) may be identified as relevant and may be logged upon their occurrence into an event log (e.g., stored in the exceptions and logs database 206) by an event logging component. The change evaluating system 101 may pull events from the event log at, for example, a pre-determined time (e.g., near real-time as the events are logged) or as a pre-determined number of events accumulate. Alternatively, the event log may push events to the change evaluating system 101 at a pre-determined time (e.g., near real-time as the events are logged) or upon accumulating a certain number of events. In various example embodiments, the change evaluating system 101 continuously monitors the machine or service for an occurrence of a change that pertains to the machine or service.

In certain example embodiments, the publish/subscribe paradigm is used to transmit notifications about changes. The publish/subscribe paradigm is a messaging pattern according to which senders of messages, called publishers, do not program the messages to be sent directly to specific receivers, called subscribers. Instead, published messages are characterized into classes, without knowledge of the identities of any subscribers. Similarly, subscribers may express interest in one or more classes, and may only receive messages that are of interest, without knowledge of what, if any, publishers exist.

To evaluate the performance of the service or machine in relation to the change, the change evaluating system 101, using a particular rule 204, may access and compare data that pertains to the performance of the service or machine before the change occurred with data that pertains to the performance of the service or machine after the change occurred. The performance data may be in the form of logs or exceptions recorded, for example, during the execution of a piece of software code, the running of a service, or the occurrence of hardware- or configuration-related events. An exception is an anomalous or exceptional event that requires special processing. Depending on the type of change (e.g., change to software, hardware, or service), the change evaluating system 101 may evaluate the performance of the service or machine based on different types of performance data, different rules, or both. For example, if the change was to the hardware of a particular machine, the change evaluating system 101 may access data from the system log file of the particular machine to receive relevant log data to be used in the evaluation of the quality of the performance of the service or machine after the change.

In addition, the change evaluating system 101 may evaluate different characteristics 203 of the performance of a service or machine. A performance characteristic 203 of a service or machine is an aspect or parameter of the performance of a service or machine that indicates how well the service or machine functions in a performance area. Examples of performance characteristics are latency, Queries Per Second (QPS), heap size growth rate, error rate, exceptions, busy Central Processing Unit (CPU) percentage, memory usage percentage (e.g., real, free, swap, avail etc.), wait CPU percentage, etc. Based on the type of change, a particular performance characteristic (also “characteristic”) 203, or both, the change evaluating system 101 may determine the type of performance data required for evaluating the performance of the service or machine and may access data sources that have the relevant performance data for the service or machine. Examples of such data sources are the exceptions and logs database 206, the GC metrics database 208, and the capacity metrics database 210.

In some example embodiments, the change evaluating system 101 accesses data that pertains to a baseline instance of the service and data pertaining to a change instance of the service. The baseline instance of the service may be an instance of the service before the change occurred. The change instance of the service may be an instance of the service after the change occurred. Data that pertains to one or more instances of the service may be recorded in one or more records of a database accessible by the change evaluating system 101. The change evaluating system 101 may access the data that pertains to a baseline instance of the service and data pertaining to the change instance of the service upon receiving the indication of the change that pertains to the service or machine.

Further, the change evaluating system 101 identifies a specific performance characteristic 203 from a plurality of performance characteristics 203 of the service. The specific performance characteristic 203 may have a first value in the baseline instance of the service and a second value in the change instance of the service. In addition, the change evaluating system 101 accesses a plurality of rules 204 that may be used to evaluate the quality of the performance of the service or machine after the change. Each of the plurality of rules 204 corresponds to one of the plurality of performance characteristics 203 of the service. In some instances, several rules 204 correspond to a particular performance characteristic 203.

Further, the change evaluating system 101 selects a particular rule 204 from the plurality of rules 204 based on the particular rule 204 corresponding to the specific performance characteristic 203. Based on the first value of the performance characteristic 203, the second value of the performance characteristic 203 and the selected particular rule 204, the change evaluating system 101 evaluates the performance of the service or machine after the change.

In some example embodiments, the evaluating by the change evaluating system 101 of the performance of the service after the change includes comparing the first value and the second value of the performance characteristic 203, determining that a difference exists between the first value and the second value of the performance characteristic 203 based on the comparing of the first value and the second value of the performance characteristic 203, and analyzing the difference between the first value and the second value of the performance characteristic 203 according to the selected particular rule 204.

In certain example embodiments, when evaluating the performance of the service after the change, the change evaluating system 101 identifies the particular rule 204 to be applied to the data that pertains to the performance of the service or machine after the change. The change evaluating system 101 also identifies a condition specified in the particular rule 204. Then, the change evaluating system 101 applies the particular rule 204 to the data and determines that the condition specified in the particular rule 204 is satisfied by the data. In some instances, the particular rule 204 indicates a maximum threshold value that a performance characteristic 203 may have. For example, the particular rule 204 may indicate a maximum threshold latency rate of a service. While evaluating the performance of the service or machine after the change, the change evaluating system 101 may determine, based on the data, that a latency rate of the service or machine determined after the change exceeds the maximum threshold latency rate.

Also shown in FIG. 2 are the ticketing system 211, the mail server 212, and the alert system 213. Upon evaluating of the performance of the service or machine after the change, the change evaluating system 101 generates an evaluation result based on the performance evaluation. The change evaluating system 101 may transmit a communication including the evaluation result to the ticketing system 211, the mail server 212, or the alert system 213. Upon receiving the communication including the evaluation result from the change evaluating system 101, the ticketing system 211 may automatically analyze the evaluation result and create a ticket based on the evaluation result, if the evaluation result is negative (e.g., is indicative of a problem). The mail server 212, upon receiving the communication including the evaluation result from the change evaluating system 101, may automatically generate an email message and transmit it to a user (e.g., the person who effected the change). Similarly, upon receiving the communication including the evaluation result from the change evaluating system 101, the alert system 213 may automatically generate and transmit an alert to a user. One or more of the ticketing system 211, the mail server 212, and the alert system 213 may be configured to generate and/or transmit respective tickets or notifications based on negative evaluation results or based on both negative and positive evaluation results.

Any of the machines, databases, or devices shown in FIG. 2 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 2 may be combined into a single machine, and the functions described herein for any single machine, database, or device may be subdivided among multiple machines, databases, or devices.

The network 214 may be any network that enables communication between or among machines, databases, and devices (e.g., the change evaluating system 101 and the ticketing system 211). Accordingly, the network 214 may be a wired network, a wireless network (e.g., a mobile or cellular network), or any suitable combination thereof. The network 214 may include one or more portions that constitute a private network, a public network (e.g., the Internet), or any suitable combination thereof.

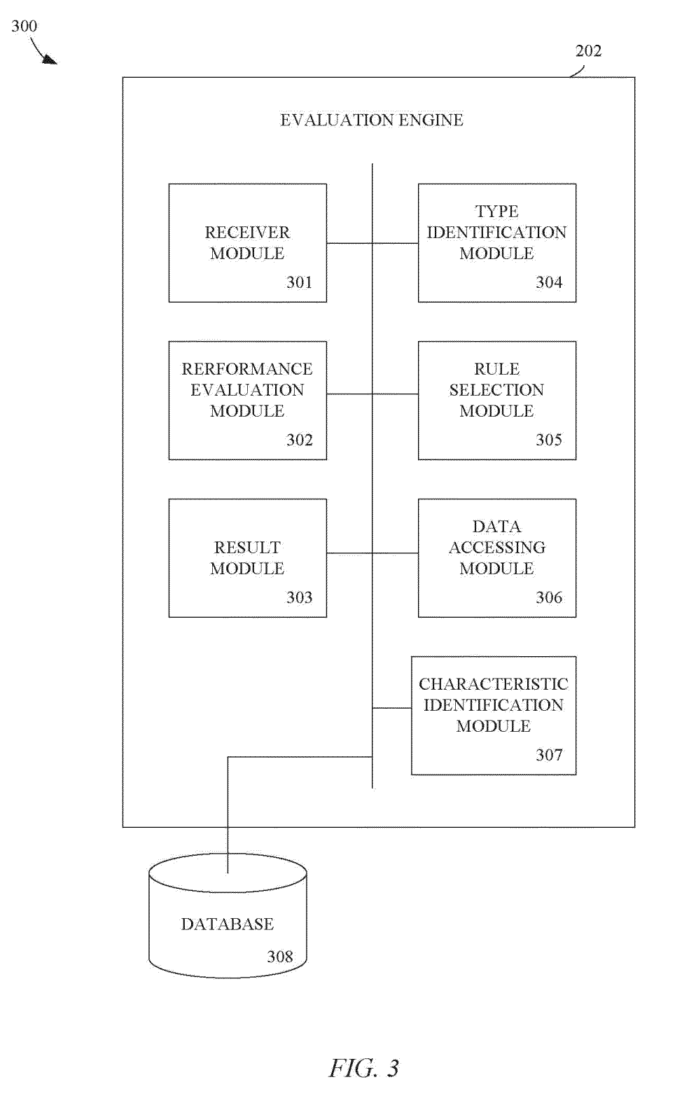

FIG. 3 is a block diagram of certain modules of an example change evaluating system, consistent with some example embodiments. Some or all of the modules of system 300 illustrated in FIG. 3 may be part of the evaluation engine 202. As such, system 300 is described by way of example with reference to FIG. 2.

The system 300 is shown to include a number of modules that may be in communication with each other. One or more modules of the system 300 may reside on a server, client, or other processing device. One or more modules of the system 300 may be implemented or executed using one or more hardware processors. In some example embodiments, one or more of the depicted modules are implemented on a server of the network-based system 100. In FIG. 3, the evaluation engine 202 is shown as including a receiver module 301, a performance evaluation module 302, a result module 303, a type identification module 304, a rule selection module 305, a data accessing module 306, and a characteristic identification module 307 configured to communicate with each other (e.g., via a bus, shared memory, or a switch). Also shown in FIG. 3 is a database 308 configured to communicate with one or more modules of the evaluation engine 202.

The receiver module 301 in FIG. 3 is configured to receive an indication of a change that pertains to a service or machine. In some example embodiments, the receiver module 301 is a listening component that is configured to automatically receive communications sent by one or more reporting components configured to report changes that pertain to services and machines. The indication of a change, in some instances, is an alert. Also, the indication of a change may be a request for a service performed by the change evaluating system 101. For example, the receiver module 301 may receive as an indication of a change a communication from a client device that includes a request for the evaluation of performance data that pertains to a service or machine. In response to receiving the request, the receiver module 301 may automatically invoke the functionality of the change evaluating system 101. Examples of client devices that may send evaluation requests to the change evaluating system 101 are the exception and log categorizing system 205, the garbage collection analyzing system 207, the redline monitoring system 209, the ticketing system 211, the mail server 212, and the alert system 213. The receiver module 301 may further be configured to continuously monitor the service or machine for an occurrence of a change that pertains to the service or machine.

The performance evaluation module 302 in FIG. 3 is configured to evaluate a performance of the service or machine after the change, using a particular rule 204 for evaluating a quality of the performance of the service or machine after the change. The particular rule 204 may be stored in a record of the database 308. The evaluation is performed in response to the receiving of the indication of the change. To evaluate the performance of the service or machine in relation to the change, the performance evaluation module 302, in some instances, compares data that pertains to the performance of the service or machine before the change with data that pertains to the performance of the service or machine after the change. In other instances, the performance evaluation module 302 analyzes the performance data after the change to determine whether a condition specified in the particular rule 204 is satisfied by the performance data. In some example embodiments, the performance data may be in the form of logs, exceptions, or metrics and may be received, for example, from the exceptions and log analyzing system 205, the garbage collection analyzing system 207, or the redline monitoring system 209.

The result module 303 in FIG. 3 is configured to generate an evaluation result based on the evaluating of the performance of the service or machine after the change. In various example embodiments, the evaluation result includes an indication of the quality of the performance of the service or machine after the change. For example, if an evaluation of a change indicates that the change has or will likely have a negative impact on the performance of the service or machine, then the result module 303 generates an evaluation result of “fail” to indicate the quality of the performance of the service or machine after the change. Similarly, if an evaluation of a change indicates that the change has no or will likely have no negative impact on the performance of the service or machine, then the result module 303 generates an evaluation result of “pass” to indicate the quality of the performance of the service or machine after the change. The “pass” or “fail” evaluation results may also be indicated numerically. In some example embodiments, the evaluation result may include a number from a pre-determined range of numbers to indicate a degree of quality of the performance of the service or machine after the change. In certain example embodiments, the result module 303 is further configured to transmit, via mail server 212, a communication including the evaluation result to a user who caused the change. The result module 303, in some instances, may transmit a communication including the evaluation result to the ticketing system 211 or the alert system 213.

The type identification module 304 in FIG. 3 is configured to determine a type of change based on the indication of the change. For example, based on an event received from the event log, the type identification module 304 may determine the type of change, such as a change to software code, hardware of a machine, or a service. Depending on the type of change, the system may evaluate the performance of the service or machine based on different types of performance data. For example, if the change was to the hardware of a particular machine, the change evaluating system 101 may access the system log file of the particular machine to obtain additional relevant log data to be used in the evaluation of the quality of the performance of the service or machine after the change.

The rule selection module 305 in FIG. 3 is configured to select one or more particular rules 204 from a plurality of rules 204 based on the type of change. The plurality of rules 204 may be stored in and accessed from one or more records of the database 308. A rule may specify a condition. Another rule may provide a minimum or maximum threshold value against which the system compares a difference between a baseline value of a performance characteristic (e.g., latency) of a service or machine and a change value of the performance characteristic.

The data accessing module 306 in FIG. 3 is configured to access data that pertains to the performance of the service or machine. In some example embodiments, the particular data accessed is based on the particular rule selected. For example, if the rule includes a threshold value against which the system compares the difference between the baseline value of the performance characteristic and the change value of the performance characteristic, the data accessing module 306 accesses data for the baseline value of the performance characteristic and the change value of the performance characteristic. If the rule specifies a condition, then accessing only the performance data captured after the change may be sufficient. In the example case of the rule specifying a condition, the performance evaluation module 302 is further configured to apply the particular rule to the performance data and determine that the condition specified in the particular rule is satisfied by the performance data.

According to some example embodiments, the type of change includes a deployment of a new version of a software code. The new version of the software code is different from a baseline (e.g., a previous) version of the software code. In response to the receiver module 301 receiving an indication of the change, the performance evaluation module 302 selects a particular rule from the plurality of rules 204 based on the type of change being the deployment of the new version of the software code. The particular rule may specify a condition (e.g., an exception appears in the new version of the software code but is absent from the baseline version of the software code). The data accessing module 306 accesses data that pertains to the performance of the service or machine after the deployment of the new version of the software code. The determining by the performance evaluation module 302 that the condition specified in the particular rule is satisfied by the data includes identifying an exception that appears in the new version of the software code and that is absent from the baseline version of the software code.

According to certain example embodiments, the type of change includes a change in a memory performance of the service. In response to the receiver module 301 receiving an indication of the change, the performance evaluation module 302 selects a particular rule from the plurality of rules 204 based on the type of change being the deployment of the new version of the software code. The particular rule may specify a condition (e.g., the memory performance of a service is at or above a baseline level based on a Java Virtual Machine spending less than a pre-determined percentage value of its time in garbage collection during an analysis period). The data accessing module 306 accesses data that pertains to the performance of the service or machine after the deployment of the new version of the software code. The determining by the performance evaluation module 302 that the condition specified in the particular rule is satisfied by the data includes determining that the memory performance of the service is at or above a baseline level based on a Java Virtual Machine spending less than a pre-determined percentage value of its time in garbage collection during an analysis period.

The characteristic identification module 307 in FIG. 3 is configured to identify a specific performance characteristic 203 from a plurality of performance characteristics 203 of the service. As discussed above, a performance characteristic of a service or machine is an aspect or parameter of the performance of a service or machine. Examples of performance characteristics are latency, QPS, heap size growth rate, error rate, exceptions, busy CPU percentage, free memory percentage, and wait CPU percentage.

The performance characteristic has one or more values which indicate how well the service or machine functions in a performance area. The values of a performance characteristic may be the same or different at different times or in different instances of the service (e.g., the baseline instance of the service and the change instance of the service). The baseline instance of the service may be an instance of the service before the change occurred. The change instance of the service may be an instance of the service after the change occurred. For example, where the type of change is a deployment of a new version of software that pertains to the service, the error rate in the change instance of the service may be higher than the error rate in the baseline instance of the service. Based on the type of change, a particular performance characteristic, or both, the system may determine the type of performance data required for evaluating the performance of the service or machine and may access data sources that have the relevant performance data for the service or machine.

In some example embodiments, as discussed above, the specific performance characteristic may have a first value in the baseline instance of the service and a second value in the change instance of the service. The data accessing module 306 accesses data pertaining to the baseline instance of the service and data pertaining to the change instance of the service once the receiver module 301 receives the indication of the change that pertains to the service or machine. The rule selection module 305 accesses a plurality of rules 204 including the particular rule for evaluating the quality of the performance of the service or machine after the change. Each rule of the plurality of rules 204 corresponds to one of the plurality of performance characteristics 203 of the service. In some instances, several rules correspond to a particular performance characteristic. Further, the rule selection module 305 selects the particular rule from the plurality of rules 204 based on the particular rule corresponding to the specific performance characteristic. Based on the first value of the performance characteristic, the second value of the performance characteristic and the selected particular rule, the performance evaluation module 302 evaluates the performance of the service or machine after the change.

In some example embodiments, the performance evaluation module 302, as part of the evaluating of the performance of the service after the change, compares the first value and the second value of the performance characteristic. If the performance evaluation module 302 determines that a difference exists between the first value and the second value of the performance characteristic based on the comparing of the first value and the second value of the characteristic, then the performance evaluation module 302 analyzes the difference between the first value and the second value of the performance characteristic according to the selected particular rule. For example, where the performance characteristic is a log rate, the analyzing of the difference includes calculating a difference between a log rate value in the change instance and a log rate value in the baseline instance. In some instances, where the performance characteristic is a latency, the analyzing of the difference between the first value and the second value of the performance characteristic according to the selected particular rule includes calculating a difference between a latency value in the change instance and a latency value in the baseline instance. In some instances, where the performance characteristic is an exception rate, the analyzing of the difference between the first value and the second value of the performance characteristic according to the selected particular rule includes calculating a difference between an exception rate value in the change instance and an exception rate value in the baseline instance.

The analyzing of the difference between the first value and the second value of the performance characteristic according to the selected particular rule, in some example embodiments, includes determining that a redline capacity metric of the change instance is below a redline capacity metric of the baseline instance. In certain example embodiments, the analyzing of the difference between the first value and the second value of the performance characteristic according to the selected particular rule, in some example embodiments includes identifying a NullPointerException in the data pertaining to the change instance of the service.

In some example embodiments, the performance evaluation module 302, as part of the evaluating of the performance of the service after the change, identifies the change instance of the service based on the indication of the change. The performance evaluation module 302 also identifies a QPS value in the change instance of the service. Then, the performance evaluation module 302 automatically selects the baseline instance of the service based on a time range of the baseline of the instance of the service (e.g., a recent instance of the service) and a substantial similarity between the QPS value in the change instance of the service and a QPS value in the baseline instance of the service (e.g., the difference between the QPS value in the change instance of the service and a QPS value in the baseline instance of the service may not exceed a pre-determined QPS threshold value).

In certain example embodiments, the rule selection module 305 identifies the particular rule to be applied to the data that pertains to the performance of the service or machine after the change. The performance evaluation module 302 identifies a condition specified in the particular rule. Further, the performance evaluation module 302 applies the particular rule to the data and determines that the condition specified in the particular is satisfied by the data. In some instances, the particular rule indicates a maximum threshold value that a performance characteristic may have. For example, the particular rule may indicate a maximum threshold latency rate of a service. While evaluating the performance of the service or machine after the change, the performance evaluation module 302 may determine, based on the data, that a latency rate of the service or machine determined after the change exceeds the maximum threshold latency rate.

Any two or more of these modules may be combined into a single module, and the functions described herein for a single module may be subdivided among multiple modules. Furthermore, according to certain example embodiments, the modules described herein as being implemented within a single machine, database, or device may be distributed across multiple machines, databases, or devices.

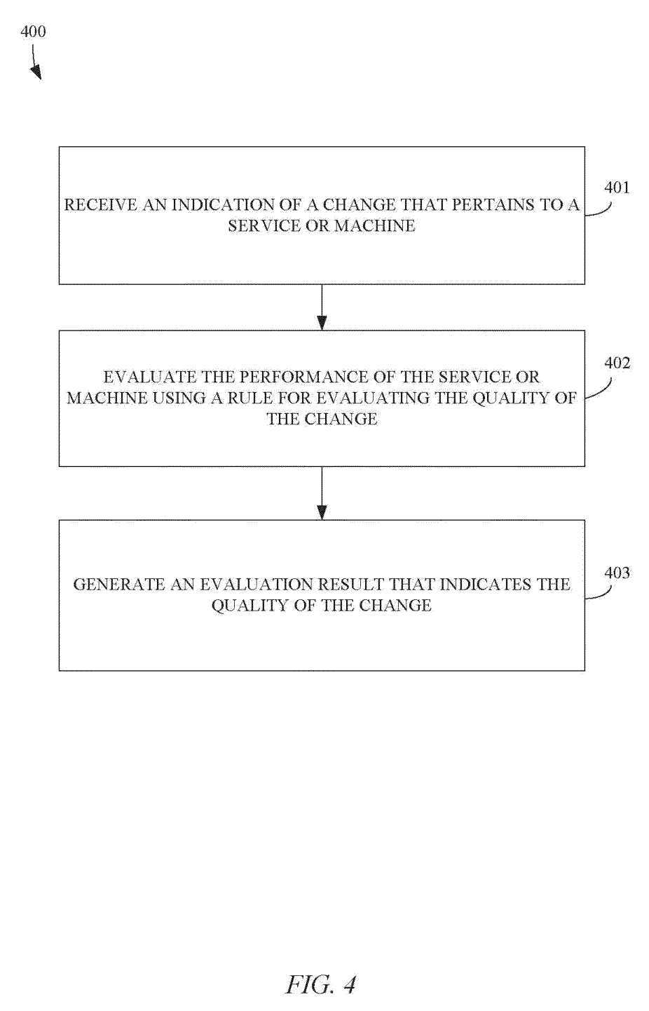

FIG. 4 is a flowchart diagram illustrating method steps of an example method 400 for evaluating a change pertaining to a service or machine, consistent with some example embodiments. The inventive subject matter may be implemented for use with applications that utilize any of a variety of network or computing models, to include web-based applications, client-server applications, or even peer-to-peer applications.

Consistent with some example embodiments, the method begins at method operation 401, when the receiver module 301 receives an indication of a change that pertains to a service or machine. With some example embodiments, the receiver module 301 receives the indications of changes near real-time (e.g., without delay, as soon as the changes occur). The indications of changes may be events from an event log that have been pushed by the event log or pulled by the receiver module 301.

At method operation 402, the performance evaluation module 302 evaluates, using at least one computer processor, a performance of the service or machine after the change, using a particular rule for evaluating a quality of the performance of the service or machine after the change. The evaluating is performed in response to the receiving of the indication of the change near real-time. In some example embodiments, the particular rule is selected from a plurality of rules that may be stored in one or more records of the database 308. The performance of the service or machine after the change may be evaluated using data that pertains to the performance of the service or machine after the change. Based on certain rules, the evaluating of the performance of the service or machine after the change may be based on performance data before the change and performance data after the change. In some example embodiments, the data that pertains to the performance of the service or machine may be stored in one or more records of the database 308.

Next, at method operation 403, the result module 303, generates an evaluation result that indicates the quality of the performance of the service or machine after the change. The evaluation result is generated based on the evaluating of the performance of the service or machine after the change. In some example embodiments, the evaluation result takes the “pass”/“fail” format. In certain example embodiments, the evaluation result may be represented in a numerical (e.g., binary) format.

In some example embodiments, the change may be a new version of software code. If the performance evaluation module 302 determines that the performance of the service based on the new version of the software code is below a pre-determined minimum performance level of the service specified in a particular rule, then the quality of the performance of the service or machine after the change is considered poor. Based on this evaluation of the performance of the service after the change (e.g., the deployment of the new version of the software code), the result module 303 generates an evaluation result which includes an indication of the poor quality of the performance of the service or machine after the change. A communication including the evaluation result may be transmitted to a user (e.g., the person who last worked on the new version of the software code). Based on receiving the communication including the evaluation result, the user may roll-back the new version of the software code and instead use an older, more stable version of the software code.

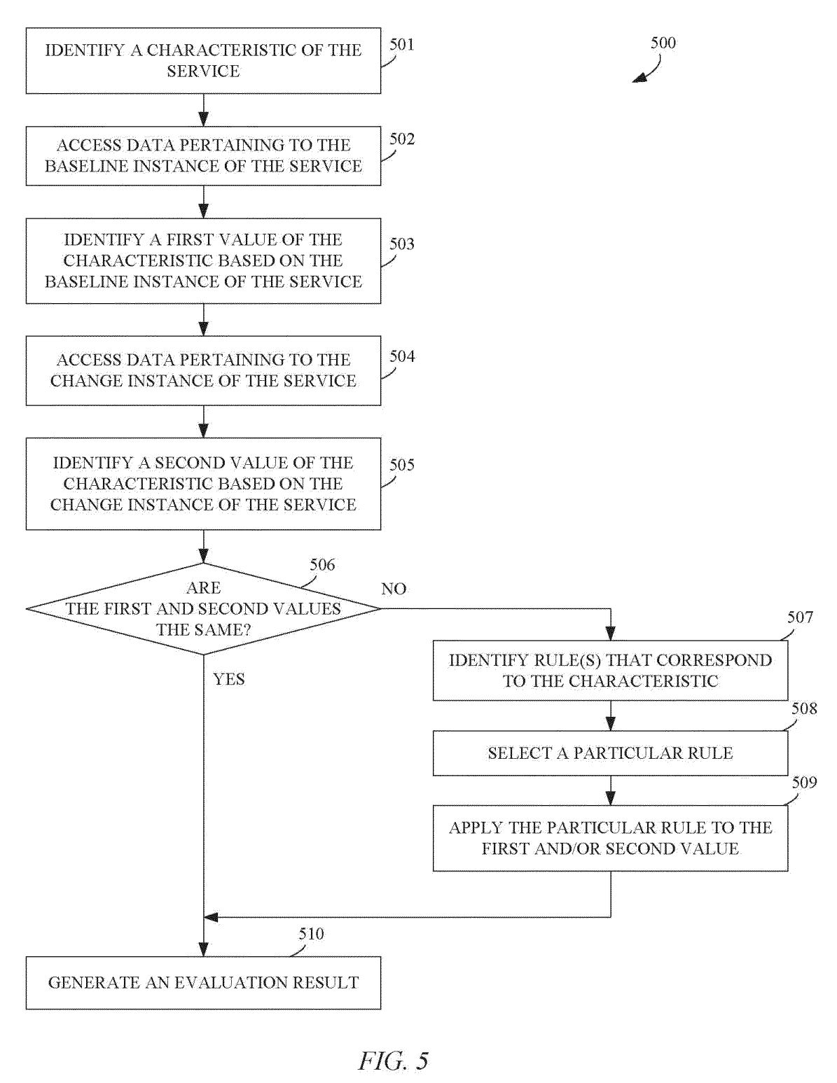

FIG. 5 is a flowchart diagram illustrating method steps of an example method 500 for evaluating a change pertaining to a service or machine, consistent with some example embodiments. The inventive subject matter may be implemented for use with applications that utilize any of a variety of network or computing models, to include web-based applications, client-server applications, or even peer-to-peer applications.

Consistent with some example embodiments, the method begins at method operation 401, when the characteristic identification module 307 identifies a specific performance characteristic of the service. At method operation 502, the data accessing module 306 accesses data pertaining to a baseline instance of a service. At method operation 503, the characteristic identification module 307 identifies a first value of the specific performance characteristic based on the data pertaining to the baseline instance of the service which was accessed at method operation 502.

At method operation 504, the data accessing module 306 accesses data pertaining to a change instance of the service. At method operation 505, the characteristic identification module 307 identifies a second value of the specific performance characteristic based on the data pertaining to the change instance of the service which was accessed at method operation 504.

At method operation 506, the performance evaluation module 302 analyzes (e.g., compares) the first value of the specific performance characteristic and the second value of the specific performance characteristic, and determines whether the first value and the second value are the same. The performance evaluation module 302 may determine, at method operation 506, that the second value of the specific performance characteristic is the same (or substantially the same) as the first value of the specific performance characteristic. If the performance evaluation module 302 determines that the first and second values of the specific performance characteristic are the same (or substantially the same), then the result module 303 generates, at method operation 510, a positive evaluation result for the performance of the service after the change.

Alternatively, the performance evaluation module 302 may determine, at method operation 506, that the second value of the specific performance characteristic is different from the first value of the specific performance characteristic. If the performance evaluation module 302 determines that the second value of the specific performance characteristic is different from the first value of the specific performance characteristic, then, at method operation 507, the rule selection module 305, identifies one or more rules that correspond to the specific performance characteristic identified at method operation 501. The rule selection module 305 selects, at method operation 508, a particular rule that corresponds to the specific performance characteristic from the one or more rules identified at method operation 507. At method operation 509, the performance evaluation 302, applies the particular rule (selected at method operation 508) to the first value, second value, or both, according to the particular rule. In some example embodiments, the performance evaluation module 302 determines and analyzes, at method operation 509, the difference between the first value of the specific performance characteristic and the second value of the specific performance characteristic according to the particular rule selected at method operation 508. According to some example embodiments, the particular rule specifies a threshold value against which the difference between the first and second values of the specific performance characteristic is measured. In certain example embodiments, the particular rule specifies a range of values against which the difference between the first and second values of the specific performance characteristic is measured. In various example embodiments, the particular rule specifies a condition (e.g., error rate should not increase by more than a pre-determined percentage value) that may or may not be satisfied by the difference between the first and second values of the specific performance characteristic.

Based on the analysis of the difference between the first value of the specific performance characteristic and the second value of the specific performance characteristic at method operation 509, the result module 303 generates, at method operation 510, an evaluation result for the performance of the service after the change. The evaluation result may be positive when, for example, the second value of the performance characteristic is determined to be above the first value of the performance characteristic, and that indicates a better performance for the specific performance characteristic of the service in the change instance of the service as compared to the baseline instance of the service. Alternatively, the evaluation result may be negative when, for example, the second value of the performance characteristic is determined to be below the first value of the performance characteristic, and that indicates a worse performance for the specific performance characteristic of the service in the change instance of the service as compared to the baseline instance of the service.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

FIG. 6 and FIG. 7 list examples of rules for evaluating the performance of the service or machine after the change, according to various example embodiments.

### Exception and Log Categorizing System

Referring back to FIG. 2, the exception and log categorizing system 205 is a tool for analyzing and categorizing exception and log data that pertain to the performance of services and machines used within the environments of an organization. In some example embodiments, the exception and log categorizing system 205 may include an exceptions and logs database 206 that stores the categorized exception and log data. In some example embodiments, the exception and log categorizing system 205 accesses exception data or log data (e.g., receives as input events a number of exceptions or logs, or both), and categorizes the exceptions or logs based on one or more rules of categorization of exception data or log data.

In some example embodiments, the categorizing performed by the exception and log categorizing system 205 is based on matching similar data elements (properties or attributes) within the logs or within stack traces. The exception and log categorizing system 205 may also identify exceptions and logs that are the same kind of exception or log, duplicates, or point to the same problem (e.g., a log says some class has an exception). Upon determining that a number of logs or exceptions are the same (e.g., indicate to the same problem) and classifying them, the exception and log categorizing system 205 stores only one copy of the many logs or exceptions that are the same (e.g., point to the same problem) in the exceptions and logs database 206. This may allow the exceptions and logs database 206 to stay small. Furthermore, this storage mechanism of the exception and log categorizing system 205 may allow the queries into the exceptions and logs database 206 to be faster. In addition to classifying the logs and exceptions in terms of uniqueness (e.g., the second event is like the first event), the exception and log categorizing system 205 counts the instances of exceptions or logs of the same type and records that count along with other pertinent data, such as the times when the exceptions occurred or the logs were generated.

In some example embodiments, the exception and log categorizing system 205 may, upon deleting duplicates and classifying the remaining exceptions and logs, generate a report that includes an indication of the number of logs or exceptions included in one or more categories. This report may be transmitted to or accessed by, for example, a person developing a product. Also, the exception and log analysis system 205 may provide an Application Programming Interface (API) to receive a request for exceptions that occurred within a particular time range for a particular service. The request may include the particular time range and the service name. In response to the request, the exception and log analysis system 205 may provide a list of exceptions for the particular service that occurred during the particular time range. The exceptions may be presented in a categorized form or along with a count of each exception type (e.g., a particular exception occurred one hundred times during the particular time).

In addition, other automated systems, such as the change evaluating system 101 and the ticketing system 211, or a variety of troubleshooting tools may be consumers of the classified exceptions and logs data stored in the records of the exceptions and logs database 206. For example, as discussed above, the change evaluating system 101 may communicate with the exception and log categorizing system 205 to access performance data that pertains to a service or machine and that is stored in the exceptions and logs database 206. The performance data (e.g., in form of exceptions or logs) may be used by the change evaluating system 101 during the evaluation of the performance of the service or machine after a change.

In some example embodiments, before categorizing the exceptions, the exception and log categorizing system 205, determines that a first exception is the same as (or substantially similar to) a second exception based on analyzing the first exception data (e.g., the first exception's stack trace) and the second exception data (e.g., the second exception's stack trace). The exception and log categorizing system 205 may compare the stack traces of the first exception and the second exception, and may identify data elements that are unique to the first exception or the second exception. An example of a unique (or dynamic) data element may be a user identification (user ID). Also, based on comparing the first exception's stack trace and the second exception's stack trace, the exception and log categorizing system 205 may identify data elements that are common to the first exception and the second exception.

The exception and log categorizing system 205 may remove (or strip) the unique elements from the first and second exceptions' stack terraces, and retain the common data elements of the first and second exceptions' stack traces. Further, the exception and log categorizing system 205 may calculate unique hash codes (e.g., Message-Digest algorithm 5 (MD5) hash codes) for the first exception and the second exception based on hashing (e.g., applying a cryptographic hash function) to the common data (the stripped stack traces) of the first exception and the second exception. Using the hash codes, the exception and log categorizing system 205 may classify the first exception and the second exception. If the hash code of the first exception coincides with the hash code of the second exception, the first exception and the second exception are categorized as being the same exception associated with the identical hash code. If the hash code of the first exception is not identical to the hash code of the second exception, the first exception and the second exception are assigned to different categories associated with the respective hash code of the first exception or second exception.

### Garbage Collection Analyzing System

The garbage collection analyzing system 207 is a tool for automated monitoring and analysis at scale of garbage collection events related to services running within the environments of a company. Garbage Collection (also referred to herein as “GC”) is a form of automatic memory management. Automatic garbage collection is the process of examining the heap memory, identifying the data objects that are no longer used by a program and deleting the unused data object in order to reclaim the resources used (e.g., the memory occupied) by those objects. The moment when the garbage (e.g., the used up memory) is collected (e.g., the used up memory is released) may be unpredictable and may result in stalls scattered throughout a session. Unpredictable stalls may be problematic in real-time environments, in transaction processing, or in interactive programs. Data that pertains to stall times and other garbage collection statistics may be accessed at the garbage collection analyzing system 207 and used in evaluating the garbage collection performance of a service by the change evaluating system 101.

For example, every Java process dumps a log called the GC log. The GC log may be used to analyze the garbage collection performance of a service. The garbage collection analyzing system 207 may collect and parse GC logs from numerous services within the environments of a company to identify GC events. Upon identifying the GC events, the garbage collection analyzing system 207 may categorize and persist each garbage collection event in a database. In addition, the garbage collection analyzing system 207 may retrieve and analyze garbage collection data based on a particular service instance or based on a plurality of service instances. Based on the analysis of the garbage collection data, the garbage collection analyzing system 207 may generate a number of garbage collection metrics. Examples of garbage collection metrics are: type of event; minor/major GC time; GC failures and cause of failure; system and user CPU utilization; memory footprints; memory freed per collection; young generation, old generation, and permanent generation memory utilization; survivor ages and memory occupancies; heap growth; full garbage collector; garbage collectors with failures; Input/Output (also “I/O”) and memory starved events; total stall time; stop the world stall times; event time range; collection times and heap statistics for different spaces or generations; time until heap exhaustion; allocation rate; promotion rate; survivor death ratio and occupancy; etc. The garbage collection analyzing system 207 may store the garbage collection metrics in the GC metrics database 208.

Other automated systems, such as the change evaluating system 101, the ticketing system 211 or the alert system 213, or a variety of troubleshooting tools may be consumers of data that pertains to garbage collection performance of services within the environments of a company. For example, as discussed above, the change evaluating system 101 may communicate with the garbage collection analyzing system 207 to access performance data (e.g., garbage collection data) for a particular service. The garbage collection data may be stored in the GC metrics database 208. The garbage collection data (e.g., GC metrics) may be used by the change evaluating system 101 during the evaluation of the performance (e.g., GC performance) of the service after a change. This may allow for proactive monitoring of GC for a service to predict GC issues before they happen in other environments. Furthermore, based on the evaluation of the GC performance of a service, the change evaluating system 101 may provide a recommendation for GC settings and steps to remediate GC problems.

The change evaluating system 101 may automatically identify GC-related problems based on rules or heuristics. The ticketing system 211 may open a ticket based on the evaluation result generated by the change evaluating system 101. The alert system 213 may generate a communication including an alert based on a determination (e.g., by the change evaluating system 101) that one of the GC metrics is outside a pre-determined range of values.

The GC metrics may also be accessed by a client device of a user of the garbage collection analyzing system 207 in response to a request by the user for one or more GC metrics. For example, in response to receiving a request that specifies the name of a service and a time range, the garbage collection analyzing system 207 may provide one or more metrics that pertain to the garbage collection performance of the particular service for the specified time range.

### Redline Monitoring System

The redline monitoring system 209 is a tool for capacity planning which automatically identifies the redline throughput for services in production. The redline throughput of a service instance is the maximum throughput that a service instance may handle without compromising performance, user experience, stability of the site, or availability under the current capacity. A benefit of the redline monitoring system 209 is the ability to monitor any changes in the capacity level of a service in response to a change in software or hardware that pertains to the service. For example, as new software code is being rolled out, the redline monitoring system 209, using live traffic, tests a particular service's ability to have the same capacity level under the new software code as the service's baseline capacity level (e.g., determined based on a previous version of the code).

Traditionally, the capacity of a service may be tested using a simulated stress test in a test environment. For example, a stress test may be performed by increasing the number of requests for a service in some simulated fashion until the process or system cannot handle the requests. The redline monitoring system 209 automates the stress test and performs it on a live (e.g., production) system. After a particular change, the redline monitoring system 209 may funnel live traffic to a particular service in the production environment and monitor the performance of the service as the service is being stressed. This process may allow the redline monitoring service 209 to determine the point (or conditions) when the service begins to degrade. The redline capacity value (e.g., the QPS) may be determined at the point of service degradation and may be represented by an integer number.

In some example embodiments, the redline monitoring system 209 determines a redline capacity metric for every service of a plurality of services. The redline capacity metric may be integrated into the capacity planning and modeling process. The redline testing may be incorporated in various example embodiments to track and reflect the capacity changes (or impact) of software code changes. The redline monitoring system 209 may perform continuous analysis and generation of redline metrics. The redline monitoring system 209 may also be invoked on-demand by a user to test a particular service. Also, the redline monitoring system 209 may be invoked automatically upon a listener component of the redline monitoring system 209 receiving a software release notification (e.g., a newly deployed service or an existing service using a new software version).

In some example embodiments, when the redline monitoring system 209 is invoked, the redline monitoring system 209 accesses a data source to obtain the baseline redline capacity value for a particular service and engages the particular service to start. The redline monitoring system 209 funnels live traffic to the machine running the service to attempt to increase the QPS value to the baseline redline capacity level. While attempting to increase the QPS value to the baseline redline capacity level, the redline monitoring system 209 monitors activities that indicate actual or possible performance problems related to the particular service or machine running the service (e.g., latency, exceptions, GC behavior, system availability, etc.) In some example embodiments, the redline monitoring system 209 may evaluate the activities that indicate performance problems and any available metrics that pertain to those activities, and may determine a new redline capacity value based on determining that at least one of the activities indicates a capacity problem. In various example embodiments, this functionality is performed by the change evaluating system 101 in response to a request for evaluation of redline capacity data by the redline monitoring system 209. The change evaluating system 101 may issue an evaluation result of “pass” if the new redline capacity number is equal to or greater than the baseline capacity number. Alternatively, the change evaluating system 101 may generate a “fail” evaluation result if the new redline value is lower than the baseline capacity value. In some example embodiments, an alert may be sent when the new redline number is below the baseline redline number.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of a machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 801 and a static memory 803, which communicate with each other via a bus 804. The computer system 800 may further include a video display unit 805 (e.g., a liquid crystal display (LCD) or a cathode ray tube (CRT)). The computer system 800 also includes an alphanumeric input device 808 (e.g., a keyboard or a touch-sensitive display screen), a user interface (UI) navigation device 806 (e.g., a mouse). The computer system 800 may additionally include a storage device 807 (e.g., drive unit), a signal generation device 809 (e.g., a speaker), a network interface device 900, and one or more sensors 901, such as a global positioning system sensor, compass, accelerometer, or other sensor.

### Machine-Readable Medium

The drive unit 807 includes a machine-readable medium 902 on which is stored one or more sets of instructions and data structures (e.g., software 903) embodying or utilized by any one or more of the methodologies or functions described herein. The instructions 903 may also reside, completely or at least partially, within the main memory 801 and/or within the processor 802 during execution thereof by the computer system 800, the main memory 801 and the processor 802 also constituting machine-readable media.

While the machine-readable medium 902 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 903 may further be transmitted or received over a communications network 904 using a transmission medium. The instructions 903 may be transmitted using the network interface device 900 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi® and WiMax® networks). The term “transmission medium” shall be taken to include any intangible medium that is capable of storing, encoding or carrying instructions for execution by the machine, and includes digital or analog communications signals or other intangible media to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving an indication of a change that pertains to a service or machine;
in response to the receiving of the indication of the change, evaluating, using at least one computer processor, a performance of the service or machine after the change, based on a particular rule for evaluating the performance of the service or machine after the change; and
generating an evaluation result based on the evaluating of the performance of the service or machine after the change, the evaluation result indicating a quality of the performance of the service or machine after the change.

2. The method of claim 1, wherein the particular rule indicates a minimum performance level of the service or machine.

3. The method of claim 1, wherein the evaluating of the performance of the service or machine after the change includes:
determining a type of change based on the indication of the change;
selecting the particular rule from a plurality of rules based on the type of change, the particular rule specifying a condition;
accessing data that pertains to the performance of the service or machine after the change;
applying the particular rule to the data; and
determining that the condition specified in the particular rule is satisfied by the data.

4. The method of claim 3, further comprising:
accessing baseline data that pertains to a performance of the service or machine before the change, the baseline data being collected during an execution of a baseline version of a software code;
accessing change data that pertains to a performance of the service or machine after the change, the change data being collected during an execution of a new version of the software code; and
wherein the evaluating of the performance of the service or machine after the change includes:
analyzing the baseline data and the change data according to the particular rule, the particular rule specifying a condition, and
determining that the condition specified in the particular rule is satisfied by the baseline data and the change data based on identifying an exception that appears in the change data and that is absent from the baseline data.

5. The method of claim 1, wherein the evaluating of the performance of the service after the change includes:
accessing data pertaining to a baseline instance of the service and data pertaining to a change instance of the service;
identifying a specific performance characteristic from a plurality of performance characteristics of the service, the specific performance characteristic having a first value in the baseline instance of the service and a second value in the change instance of the service;
accessing a plurality of rules including the particular rule for evaluating the quality of the performance of the service or machine after the change, wherein each rule of the plurality of rules corresponds to one of the plurality of performance characteristics of the service; and
selecting the particular rule from the plurality of rules based on the particular rule corresponding to the specific performance characteristic.

6. The method of claim 5, wherein the evaluating of the performance of the service after the change further includes:
comparing the first value of the performance characteristic and the second value of the performance characteristic;
determining that a difference exists between the first value of the performance characteristic and the second value of the performance characteristic based on the comparing of the first value of the characteristic and the second value of the characteristic; and
analyzing the difference according to the selected particular rule.

7. The method of claim 6, wherein the performance characteristic is a log rate and the analyzing of the difference includes calculating a difference between a log rate value in the change instance and a log rate value in the baseline instance.

8. The method of claim 6, wherein the performance characteristic is a latency of a service and the analyzing of the difference includes calculating a difference between a latency value in the change instance and a latency value in the baseline instance.

9. The method of claim 6, wherein the performance characteristic is an exception rate and the analyzing of the difference includes calculating a difference between an exception rate value in the change instance and an exception rate value in the baseline instance.

10. The method of claim 6, wherein the analyzing of the difference includes determining that a redline capacity metric of the change instance is below a redline capacity metric of the baseline instance.

11. The method of claim 6, wherein the analyzing of the difference includes identifying a NullPointerException in the data pertaining to the change instance of the service.

12. The method of claim 5, further comprising:
identifying the change instance of the service based on the indication of the change;
identifying a Queries Per Second value in the change instance of the service; and
automatically selecting the baseline instance of the service based on a time range of the baseline of the instance of the service and a substantial similarity between the Queries Per Second value in the change instance of the service and a Queries Per Second value in the baseline instance of the service.

13. The method of claim 1, wherein the evaluating of the performance of the service or machine after the change includes determining that a latency rate of the service or machine determined after the change exceeds a maximum threshold latency rate.

14. The method of claim 1, further comprising:
transmitting a communication including the evaluation result to a user who caused the change.

15. The method of claim 1, further comprising:
continuously monitoring the service or machine for an occurrence of a change that pertains to the service or machine.

16. The method of claim 1, wherein the change is a modification of hardware of the machine.

17. The method of claim 1, wherein the change is a modification in a pattern of traffic to a web site.

18. A system comprising:
a receiver module configured to receive an indication of a change that pertains to a service or machine;
a performance evaluation module implemented by at least one computer processor and configured to, in response to the receiving of the indication of the change, evaluate a performance of the service or machine after the change, based on a particular rule for evaluating the performance of the service or machine after the change; and
a result module configured to generate an evaluation result based on the evaluating of the performance of the service or machine after the change, the evaluation result indicating a quality of the performance of the service or machine after the change.

19. The system of claim 18, further comprising:
a type identification module configured to determine a type of change based on the indication of the change;
a rule selection module configured to select the particular rule from a plurality of rules based on the type of change, the particular rule specifying a condition; and
a data accessing module configured to access data that pertains to the performance of the service or machine after the change, and
wherein the performance evaluation module is further configured to
apply the particular rule to the data and
determine that the condition specified in the particular rule is satisfied by the data.

20. A non-transitory machine-readable medium comprising instructions, which when implemented by one or more processors, perform the following operations:
receiving an indication of a change that pertains to a service or machine;
in response to the receiving of the indication of the change, evaluating a performance of the service or machine after the change, based on a particular rule for evaluating the performance of the service or machine after the change; and
generating an evaluation result based on the evaluating of the performance of the service or machine after the change, the evaluation result indicating a quality of the performance of the service or machine after the change.
